(19) United States
(12) Patent Application Publication
(10) Pub. No.: US 2017/0121089 A1
(43) Pub. Date: May 4, 2017

(54) FOOD TRAY AND METHOD FOR PRODUCING SUCH A FOOD TRAY

(71) Applicant: TORUS PAK RESEARCH AND DEVELOPMENT S.A.R.L., Luxembourg (LU)

(72) Inventor: Rickard Gillblad, Onsala (SE)

(73) Assignee: TORUS PAK RESEARCH AND DEVELOPMENT S.A.R.L., Luxembourg (LU)

(21) Appl. No.: 15/319,664

(22) PCT Filed: Jun. 17, 2015
(86) PCT No.: PCT/EP2015/063651

§ 371 Date: Dec. 19, 2016

(30) Foreign Application Priority Data
Jun. 17, 2014 (EP) PCT/EP2014/062751

(51) Int. Cl. B65D 77/30; B65D 1/36; B29C 51/26; B65B 7/28; B29C 51/00; A47G 23/06; B65D 77/20

(52) U.S. Cl. CPC B65D 77/30; A47G 23/06; B65D 1/36; B65D 77/2024; B65B 7/2878; B29C 51/002; B29C 51/266; B29K 2067/003

(57) ABSTRACT

A food tray comprising a side wall module and a removable bottom, where the side wall module comprises a lower opening delimited by a lower rim of the side wall module, where the removable bottom is attached to the lower rim of the side wall module in a detachable manner such that the lower opening is closed off by the removable bottom, where the removable bottom can be removed from the side wall module by the use of a removal means attached to the bottom, where the side wall module is formed by removing a bottom part inside the lower rim of the side wall module, thereby creating the lower opening. One advantage of this food tray is that a food tray having a removable bottom adapted for higher heating temperatures is provided.

### TECHNICAL FIELD

The present invention relates to a food tray adapted for ready meals and the like comprising a detachable bottom and a method for producing such a food tray.

### BACKGROUND ART

There is an increasingly large demand for meals that are simple to prepare and for which the preparation time is short. Sales of convenience foods or ready meals are increasing. These are sold in disposable packages and are adapted either to be eaten directly without heating, such as sushi, or to be heated before eaten.

Most ready meals are contained in a disposable package usually consisting of a tray manufactured from cardboard, metal or a plastic material with a thin, transparent plastic film serving as a lid. A plurality of different heating methods is available, depending on the packaging material. The most common tray material for single portion ready meals is plastic or paper, which allows the meal to be heated in a microwave oven. It is also possible to use a conventional oven or to place the package in hot water. The lid of the package is removed either before or after heating. The meal can be eaten directly from the package when heated or it is possible to transfer the food from the package to a plate. During a transfer of the food, the presentation of the meal is destroyed and the food content will inevitable mix. If the food is frozen, it may be possible to transfer the food to a plate prior to heating without too much problems, but for a non-frozen meal, the transfer of food is not practical. It is further an advantage to heat the meal in the package before moving it to a plate.

One way of solving the problem with the food mixing is to use a food package having a removable bottom, which is removed by the use of a pulling tab. The food package is placed on a plate before or after it is heated, and the bottom is removed by the use of the pulling tab. In this way, the food will be placed on the plate with the same presentation as in the food package, which will enhance the eating experience. Such a food package is disclosed in WO 2006/115457.

Such a food package is produced by injection moulding a container part without a bottom, i.e. a container part substantially only comprising side walls with upper and lower rims is produced. A removable bottom consisting of a relatively thin foil is then attached to the bottom rim of the container part in a detachable manner. The removable bottom comprises a removal tab to be used to remove the bottom.

Since food packages are disposable, production cost is an important parameter. There are several different plastic materials that can be used to form a container part without a bottom by injection moulding, in order to be able to provide a food tray with a removable bottom. However, most plastic materials that can be used for injection moulding are relatively expensive. One material that is suitable for disposable food trays is polypropylene (PP), also known as polypropene. Polypropylene has good injection moulding properties and is relatively cheap and is further recyclable which is of advantage for disposable packages.

One drawback of polypropylene is the relatively low melting temperature. A food tray made from polypropylene that is adapted to comprise the food when heating is well suited for the use of a microwave oven for the heating of the food. The microwave oven does not heat the package and the food is not heated to very high temperatures. A maximal usable temperature for a polypropylene package is 121° C. When using a regeneration oven to heat frozen food in a polypropylene food tray, the temperature is set to a relatively low temperature, typically to a temperature between 80° C. up to 115° C., which gives a relatively long heating time, in the order of 45 minutes to 60 minutes, depending on the type of food.

For some use, such as catering ovens used e.g. in airplanes or trains, a more rapid heating is of advantage. This is due both to limited space and limited time. The regeneration oven is thus set to a higher temperature, typically in the range between 150° C. to 220° C. Especially for airplanes, only the two oven temperatures of 180° C. and 210° C. are approved for heating food. In this case, polypropylene food trays cannot be used.

There is thus room for an improved food tray having a removable bottom.

### DISCLOSURE OF INVENTION

An object of the invention is therefore to provide a method for producing an improved food tray comprising a removable bottom. A further object of the invention is to provide an improved food tray comprising a removable bottom.

The solution to the problem according to the invention is described in the characterizing part of claim 1 for the method and in claim 8 for the food tray. The other claims contain advantageous embodiments and further developments of the method and the food tray.

In a method for producing a food tray, where the food tray comprises a side wall module and a removable bottom, where the removable bottom is attached to the side wall module in a detachable manner, and where the removable bottom can be removed from the side wall module by the use of a removal means attached to the bottom, the object of the invention is solved in that the method comprises the steps of: producing a food tray having side walls and a bottom part by thermoforming the food tray from a plastic sheet, removing the bottom part from the food tray, and attaching a removable bottom in a detachable manner to a lower rim of the food tray.

By this first embodiment of the method for producing a food tray according to the invention, the method comprises the step of producing a food tray comprising side walls and a bottom part from a plastic sheet material. The bottom part is thereafter removed in order to create a lower opening, which is closed off with a removable bottom foil. In this way, a food tray having a removable bottom can be produced in a cost-effective and efficient way. One advantage of this method is that food trays having a removable bottom adapted for higher heating temperatures, e.g. temperatures exceeding 115° C. and e.g. ranging between 150° C. up to 210° C. can be produced. A further advantage is that the production of food trays can be distributed to production facilities producing smaller quantities of food trays, since there is no need to use injection moulding for the production. The removal of the bottom part may be made by cutting or stamping. If the opening is cut, it may be cut using laser cutting.

A further advantage with the inventive method is that food trays having a removable bottom can be produced in odd sizes or shapes in small quantities, since the tooling is cheaper and simpler than injection moulding tools. This may e.g. be advantageous for cakes of different types, which are often relatively high and use different shapes. By using an ordinary cake tray and providing it with a removable bottom, the cake can be transferred to a plate in an easy way without damaging the cake.

In an advantageous development of the invention, the food tray comprises a plurality of compartments delimited by one or more dividers. The dividers are preferably incorporated with the side wall module, but may also be dividers attached to the side wall module. This allows two or more different food types to be stored in the same food tray without mixing until the point in time when the food is served. Such dividers may further increase the rigidity of the food tray, and will at the same time provide separation of the different food types.

### BRIEF DESCRIPTION OF DRAWINGS

The invention will be described in greater detail in the following, with reference to the embodiments that are shown in the attached drawings, in which

FIG. 1 shows a side view of a food tray comprising a removable bottom according to the invention,

FIG. 2 shows a cross section of a food tray according to FIG. 1,

FIG. 3 shows a cross section of a food tray before the bottom part is removed,

FIG. 4 shows an example of a food tray comprising a plurality of food compartments, and

FIG. 5 shows a schematic flow chart of the method according to the invention.

### MODES FOR CARRYING OUT THE INVENTION

The embodiments of the invention with further developments described in the following are to be regarded only as examples and are in no way to limit the scope of the protection provided by the patent claims.

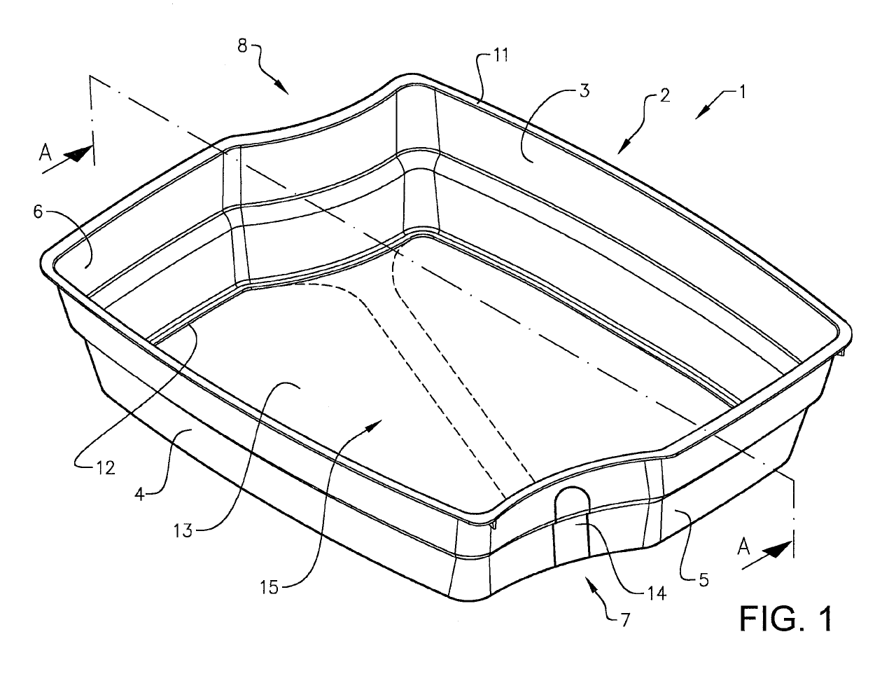

FIG. 1 shows an embodiment of a food package in the form of a food tray 1. The food tray 1 comprises in the shown example a side wall module 2 having two longitudinal side walls 3, 4 and two transverse side walls 5, 6 interconnected to each other, thereby forming the side wall module 2 made in one piece. The food tray further comprises a removable bottom 13 attached in a removable manner to the underside of the lower rim 12 of the side wall module. The removable bottom 13 closes off a lower opening 15 of the side wall module 2. The side walls 3, 4 and 5, 6 are substantially perpendicular to each other, but the side wall module may also have other shapes, such as a round, an oval or an asymmetric shape. A rectangular outer shape is however cost-efficient both to handle and to pack in larger quantities. The shown transverse side walls each comprise a concave section 7, 8. The concave section 7 is intended to hold the removal tab 14 of the removable bottom and to provide a grip for holding the food tray when the removable bottom is removed. The removal tab 14 is fixed to the removable bottom at the opposite end, at the concave section 8, which means that the removable bottom will start to peel off from this end when the removal tab is pulled.

The side walls slope somewhat such that the food trays can be stacked in each other. This allows for an efficient transportation of empty food trays. The lower periphery of the side wall module is provided with a lower rim 12 that is adapted to receive a bottom foil that will constitute the removable bottom 13 of the food tray. The bottom foil is attached to the underside of the lower rim 12 in a removable manner, such that a removable bottom is provided. The bottom foil can be removed by pulling the removal tab 14. The removable bottom foil is preferably attached in a removable manner to the side wall module when the food tray is produced. There are different ways of achieving an attachment of the bottom that allows it to be removed in an easy way, but that will still provide a secure bottom for the food before the removal of the bottom. Since the removable bottom is peeled off, the local pulling strength acting on the joint will be relatively high which helps the removal of the bottom.

The upper periphery of the food package comprises an upper rim 11 that is adapted to receive a lid of some kind. The lid may be made from different materials but is preferably a transparent film that is attached to the upper rim after food has been placed in the tray. The lid does not have to be removed from the tray when the food in the tray is to be served. The lid may thus be attached to the upper rim in a fixed manner. This allows for an easier attachment of the lid, which is of great importance especially when the food tray is used by smaller establishments having simpler sealing machines. A removable lid requires higher tolerances when the lid is attached to the tray, but with the inventive tray, a tight and secure attachment of the lid may be obtained also with lower tolerances.

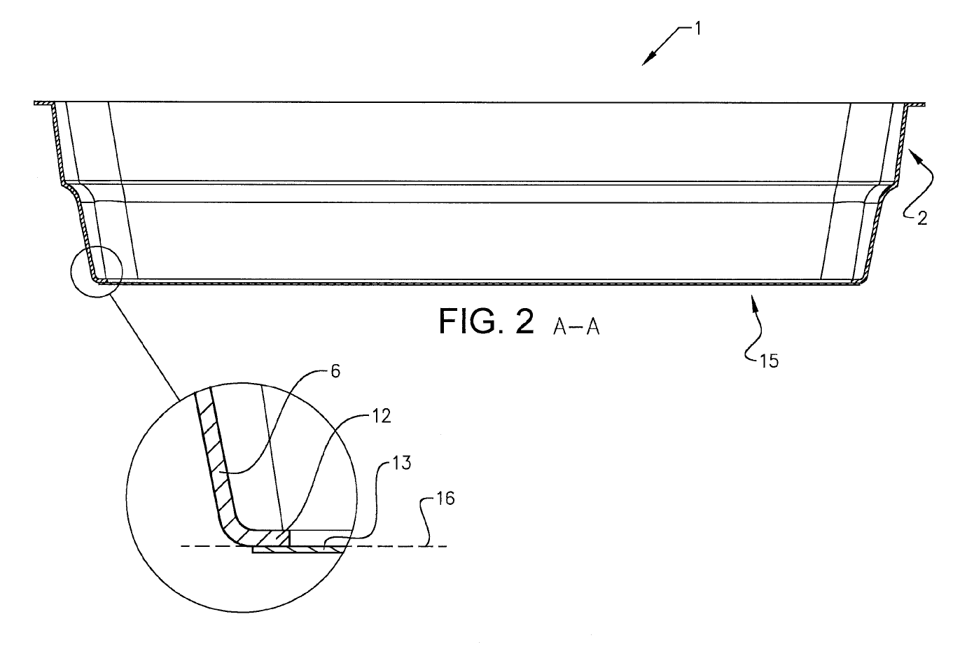

The side wall module 2 is provided with a lower opening 15 delimited by the lower rim 12 of the side wall module. The lower opening covers substantially the complete bottom plane 16 of the side wall module. In this way, everything that is placed on the removable bottom 13 in the food tray will arrive at the plate on which the food tray is placed, when the removable bottom is removed. FIG. 2 shows a cross section of the food tray 1.

Food trays of this type are often produced using an injection moulding process. In order to provide a side wall module without a bottom, injection moulding is an efficient method. However, there are situations in which injection moulding is not an optimal choice. One such situation is when a food tray adapted for heating in higher temperatures is desirable. Since one of the few, or maybe the only, plausible material for injection moulding a food tray is polypropylene, and polypropylene has a usable upper temperature limit of 121° C., food trays of injection moulded polypropylene cannot be used for heating food in temperatures higher than 115° C.

In situations in which a higher efficiency is required, such as when a larger number of frozen food trays are to be heated at the same time, a higher heating temperature is used. Typically, a regeneration oven is set to a temperature in the range of 150° C.-180° C. In this way, the heating time for a typical meal can be reduced from over 45 minutes to around 20 minutes, which means that the capacity is more than doubled. When space limitation is an issue, such as in trains or airplanes, this is a great advantage. A further limiting factor for the material used in the food tray is that the only approved temperatures in airplane ovens are 180° C. or 210° C., which disqualifies polypropylene food tray.

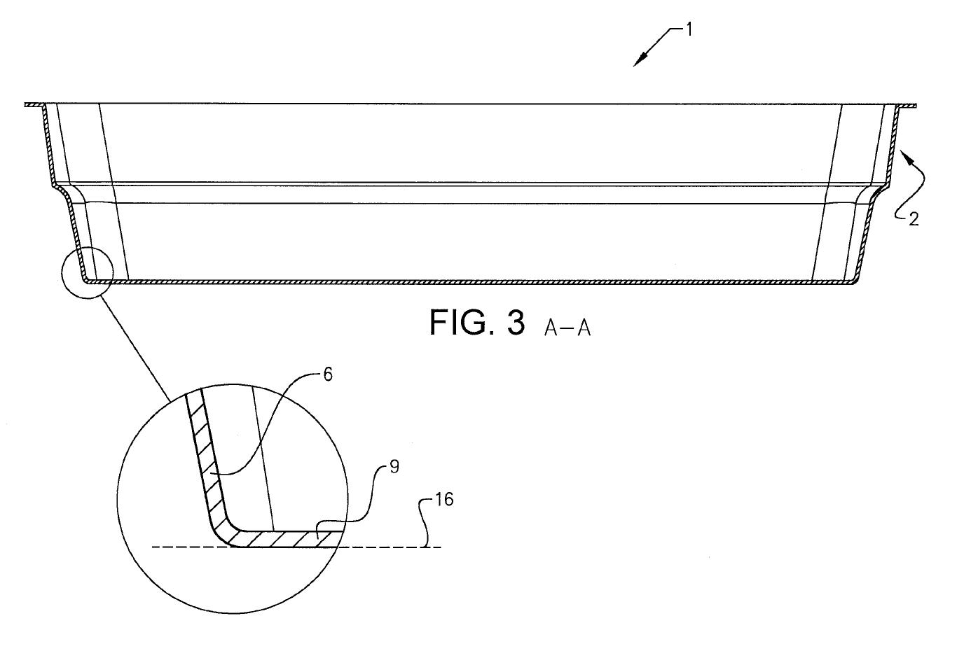

In the inventive method, a food tray comprising a side wall module and an integral bottom part is produced from a plastic sheet in a thermoforming process. A plastic sheet is heated to a specific temperature and is then placed on a mould corresponding to the shape of the desired food tray. The material of the plastic sheet is preferably polyethylene terephthalate (PET), and more preferably crystalline polyethylene terephthalate (CPET). The sheet is stretched into or onto the mould, e.g. by using vacuum or a mating mould. When the sheet is cooled down, the outer edge is trimmed such that the food tray receives its final shape. Conventional food trays, which do not have a removable bottom and which are adapted for higher heating temperatures, are often produced in this way. An example of such a food tray comprising an integrated bottom part 9 is shown in FIG. 3.

For the inventive food tray, the bottom part 9 is removed from the resulting food tray. In this way, a lower opening 15 is created in the lower region of the food tray, which substantially covers the complete bottom of the food tray. This lower opening is closed off by the use of a removable bottom, which is applied in a detachable manner to the lower rim 12 of the side wall module. The removal of the bottom part may be made by cutting or stamping. If the opening is cut, it may be cut using laser cutting.

By the inventive method for producing a food tray having a removable bottom, a food tray with a removable bottom is provided, which is possible to use in a regeneration oven heating with a temperature of over 150° C. A further advantage is that it is possible to distribute the production facilities in order to produce smaller quantities of food trays, since the production tools are relatively cheap. With a relatively cheap production tool, it is also possible to produce food trays of odd sizes and shapes that are only to be produced in smaller numbers. In this way, it is easy to provide a variety of different food trays with a removable bottom in an easy and cost-effective way. This may e.g. be advantageous for cakes of different types, which are often relatively high. By using an ordinary cake tray and providing it with a removable bottom, the cake can be transferred to a plate in an easy way without damaging the cake.

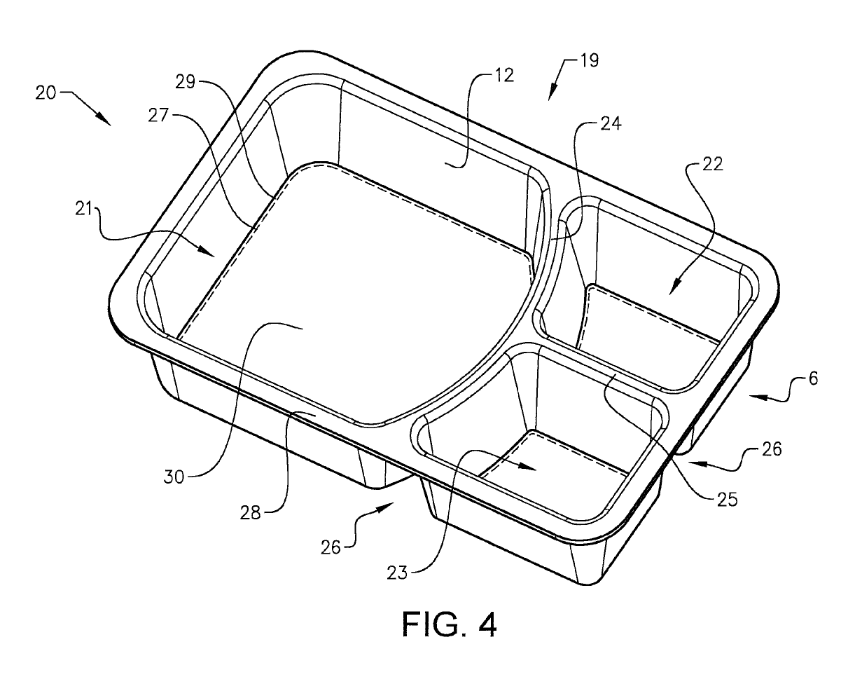

In an advantageous development of the invention, shown in FIG. 4, a food tray 19 comprising a side wall module 20 adapted for the use with a removable bottom is shown. The side wall module 20 comprises a plurality of compartments 21, 22, 23 delimited by one or more dividers 24, 25. The dividers are preferably incorporated with the side wall module, but may also be dividers attached to the side wall module. This allows two or more different food types to be stored in the same food tray without mixing until the point in time when the food is served. Such dividers may further increase the rigidity of the food tray, and will at the same time provide separation of the different food types. There are spaces 26 provided between the dividers, such that the side wall modules can be stacked in each other before the removable bottom is attached in a detachable manner.

The side wall module is produced in a thermoforming process as described above. Each compartment of the side wall module will thus be provided with a bottom part 30. Each bottom part 30 will be cut or stamped away along a cut mark 27, which will only leave a lower rim 29 at the lower region of the side wall module. The side wall module will also be provided with an upper rim 28, adapted for the attachment of a lid.

The food tray is adapted to be supplied with food in a filling station at a ready meal producer. This may be either a manually operated filling station or an automated filling station. When all food products are inserted into the food tray, a lid is mounted to the upper rim of the food tray. The lid is preferably mounted to the food tray in a heat sealing operation, but it is also possible to use a lid that is not fixedly attached to the upper rim, e.g. when fresh ready meals are prepared for catering. Commonly known heat sealing apparatuses or machines comprising a heated plate may be used, but since the lid should not be removable, other materials, temperatures and processing times may be used.

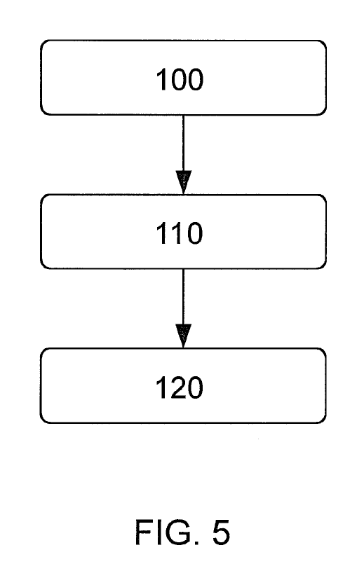

A flow chart of a method for producing a food tray, where the food tray comprises a side wall module and a removable bottom attached to a lower rim of the side wall module in a detachable manner is shown in FIG. 5. The removable bottom can be removed from the side wall module by the use of a removal tab.

In step 100, a food tray having side walls and a bottom part is produced by thermoforming the food tray from a plastic sheet. A suitable material is polyethylene terephthalate (PET). By using PET, a food tray having a removable bottom that withstands temperatures in the range between 150° C. up to 210° C. can be obtained.

In step 110, the bottom part is removed from the food tray by cutting or stamping away the bottom part, such that a side wall module having a lower opening is obtained.

In step 120, a removable bottom is attached in a detachable manner to a lower rim of the food tray. In this way, a food tray with a removable bottom obtained in a cost-effective way.

The invention is not to be regarded as being limited to the embodiments described above, a number of additional variants and modifications being possible within the scope of the subsequent patent claims. The food tray may have any size and/or shape.

### REFERENCE SIGNS

1: Food tray

2: Side wall module

3: Longitudinal side wall

4: Longitudinal side wall

5: Transverse side wall

6: Transverse side wall

7: Concave section

8: Concave section

9: Bottom part

11: Upper rim

12: Lower rim

13: Removable bottom

14: Removal tab

15: Lower opening

16: Bottom plane

19: Food tray

20: Side wall module

21: Compartment

22: Compartment

23: Compartment

24: Divider

25: Divider

26: Space

27: Cut mark

28: Upper rim

29: Lower rim

30: Bottom part

1. Method of producing a food tray, where the food tray comprises a side wall module (2) and a removable bottom (13), where the removable bottom (13) is attached to the side wall module (2) in a detachable manner, and where the removable bottom (13) can be removed from the side wall module (2) by the use of a removal means (14) attached to the bottom (13), characterized in that the method comprises the steps of:
producing a food tray having side walls and a bottom part by thermoforming the food tray from a plastic sheet,
removing the bottom part from the food tray by cutting or stamping, and
attaching a removable bottom in a detachable manner to a lower rim of the food tray.

2. Method according to claim 1, characterized in that the food tray is formed from a plastic sheet made of polyethylene terephthalate (PET).

3. Method according to claim 2, characterized in that the food tray is formed from a plastic sheet made of crystalline polyethylene terephthalate (CPET).

4. Method according to any of claims 1 to 3, characterized in that the bottom part is removed from the food tray by stamping.

5. Method according to any of claims 1 to 3, characterized in that the bottom part is removed from the food tray by cutting.

6. Method according to claim 5, characterized in that the bottom part is removed from the food tray by laser cutting.

7. Method according to any of the preceding claims, characterized in that a plurality of compartments are formed in the food tray.

8. A food tray (1) comprising a side wall module (2) and a removable bottom (13), where the side wall module (2) comprises a lower opening (15) delimited by a lower rim (12) of the side wall module (2), where the removable bottom (13) is attached to the lower rim (12) of the side wall module (2) in a detachable manner such that the lower opening (15) is closed off by the removable bottom (13), where the removable bottom (13) can be removed from the side wall module (2) by the use of a removal means (14) attached to the bottom (13), characterized in that the side wall module (2) is formed by removing a bottom part (9) inside the lower rim (12) of the side wall module, thereby creating the lower opening (15).

9. Food tray according to claim 8, characterized in that the lower opening (15) is formed by cutting or stamping

10. Food tray according to claim 8 or 9, characterized in that the food tray is formed from a plastic sheet made of polyethylene terephthalate (PET).

11. Food tray according to claim 10, characterized in that the food tray is formed from a plastic sheet made of crystalline polyethylene terephthalate (CPET).

12. Food tray according to any of claims 8 to 11, characterized in that the side wall module comprises a plurality of compartments (21, 22, 23).

13. Method according to claim 12, wherein the compartments are defined by one or more dividers (24, 25) incorporated into, or adhering to, the side wall module.
